(19) United States
(12) Patent Application Publication
(10) Pub. No.: US 2005/0083628 A1
(43) Pub. Date: Apr. 21, 2005

(54) Close tolerance surge suppression circuit

(76) Inventor: Leo L. Holzenthal JR., New Orleans, LA (US)

Correspondence Address: Lance A. Foster;Jones, Walker, Waechter,, Poitevent, Carrere & Denegre, L.L.P., 8555 United Plaza Boulevard, 4th Floor, Baton Rouge, LA, 70809, US

(21) Appl. No.: 10/688,093

(22) Filed: Oct. 17, 2003

(51) Int. Cl. H02H 9/06

(52) U.S. Cl. 361/118

(57) ABSTRACT

A surge suppression circuit having a plurality of energy dissipating elements such as metal oxide varistors wherein all of the varistors have a nominal voltage within less than approximately ±5% of one another. In a preferred embodiment, the nominal voltage of the varistors will be within less than ±1% of one another and the surge suppression circuit will further include a thermal cutoff device.

### I. TITLE OF INVENTION

Close Tolerance Surge Suppression Circuit.

### II. CROSS-REFERENCE TO RELATED APPLICATION

None.

### III. STATEMENT REGARDING FEDERALLY SPONSORED RESEARCH OR DEVELOPMENT

None.

### IV. FIELD OF INVENTION

The present invention generally relates to Transient Voltage Surge Suppressors (TVSSs) and in particular TVSSs with closely matched energy dissipation elements.

### V. BACKGROUND OF INVENTION

TVSS systems are well known in the art. It is desirable to eliminate, to the extent possible, transient voltages in electrical power systems since such voltages may damage electrical apparatus such as motors and household appliances connected to the power systems. In addition, such transient voltages may cause the electrical apparatus to overheat so that it operates less efficiently and thus at a greater cost to the user. Transient voltages are produced in electrical circuits by such events as relay switching, motor commutator cycling, contact arcing, and in general any repetitious on/off cycling events. Also, transient voltages may be caused by atmospheric events such as lightning and this type of transient voltage can be especially destructive to electrical apparatus.

Transient voltage suppression is generally achieved with the use of various types of voltage clamping devices which are coupled between the power lines of a system and earth ground. When the voltage on a power line exceeds some predetermined level, the voltage clamping device becomes conductive to thereby “clamp” or maintain the voltage on the line at or below the predetermined level. One of the more common voltage clamping devices is the metal oxide varistor (MOV). As suggested in FIG. 1 the TVSS is positioned between a power source 2 and ground 4. A typical TVSS will comprise one or more MOVs connected in parallel and positioned in series with the power line 3 and ground 4. Cut-off device 10 will sense abnormal operation of the circuit and trigger an open circuit condition, thereby stopping the flow of current to the MOVs 6. In the embodiment of FIG. 1, cut-off device 10 is a thermal cut-off device which is triggered when the temperature within the TVSS enclosure reaches a predetermined level. For example, a MOV which has failed as a short circuit or is subject to sustained overload conditions will typically generate sufficient heat to trigger thermal cutoff device 10. A resistor 7 will drop the voltage in line 3 to a suitable level to operate light emitting diode (LED) 8 while diode 9 blocks the reverse polarity component of the AC wave for the LED 8. This LED circuit operates as an indicator that cut-off device 10 has not been triggered and that current is not conducting through the MOVs 6.

A MOV is a monolithic device consisting of many grains of a metal oxide, such as zinc oxide (ZnO), mixed with other materials, and compressed into a single form. The boundaries between individual grains behave as P-N junctions and the entire mass may be represented as a series-parallel diode network. When an MOV is biased, some grains are forward biased and some are reverse biased. As the voltage is increased, a growing number of the reversed biased grains exhibit reverse avalanche characteristics and begin to conduct significant current (i.e., not just a leakage current). This point where the MOV begins to conduct may be referred to as the nominal voltage and is the voltage at which the device changes from the off state to the on state and enters its conduction mode of operation. Through careful control in manufacturing, most of the non-conducting P-N junctions can be made to turn on at an approximate voltage. However, manufacturing tolerances mean that this voltage is not exactly the same in each MOV, and the typical manufacturing tolerance may be as much as ±10 percent. Normally an MOV is rated by its manufacturer to begin conducting between a given range of voltages, such as between 185 and 227 volts (i.e., +10% of a median voltage of 206).

When operating properly, a surge in voltage across the TVSS which exceeds the MOVs' turn on voltage will cause the MOVs to begin conducting and to shunt current to the ground line 4, thereby limiting surge current directed to the load and limiting the voltage to the MOVs' nominal voltage. However, because prior art TVSSs make no attempt to closely match MOVs with similar nominal voltages, it is not unusual for one MOV to have a much lower nominal voltage than the other MOVs in the TVSS. For example, if the MOV 6a in FIG. 1 has a 185V nominal voltage and the MOVs 6b and 6c have a 225V nominal voltage, any surge above 185 volts will cause MOV 6a to conduct far sooner than MOVs 6b and 6c. Thus, far more current is conducted through MOV 6a than would be if MOVs 6b and 6c were conducting equal portions of the current. Importantly, when an MOV conducts current in its breakdown region, the MOV is degraded as some of the ZnO crystals become fused. Moreover, this degradation is cumulative with the number of times the MOV conducts significant current and with the magnitude of the current. Eventually, the MOV with the lower turn-voltage is likely to fail prior to the other MOVs and sooner than it normally would if all the MOVs had virtually the same nominal voltage. Of even greater concern, when no attempt is made to closely match the MOVs, the actual energy absorption ability or rating of the TVSS is significantly less than when the MOVs are closely matched. The prior art generally presumes that the energy transferred or deposited to the TVSS is uniformly distributed to the MOVs and the energy absorption rating of the TVSS is directly proportional to the number of MOVs in the TVSS. Thus, if an MOV is rated by the manufacturer to absorb 70 joules, it is presumed that a TVSS with three MOVs can be rated as having approximately a 210 joules energy absorption capacity. However, it has been discovered that this is not the case where the MOVs are not closely matched.

### VI. SUMMARY OF INVENTION

The present invention comprises a surge suppression circuit formed by first testing a series of energy dissipating elements to identify a plurality of energy dissipating elements each having a nominal voltage within less than approximately ±5% of a mean nominal voltage of said plurality; and then assembling the energy dissipating elements into a surge suppression circuit. In a preferred embodiment, the nominal voltage of the varistors will be within less than ±2% of the mean nominal voltage and the surge suppression circuit will further include a thermal cutoff device.

### VII. BRIEF DESCRIPTION OF DRAWINGS

FIG. 1 illustrates a TVSS circuit constructed according to the present invention.

FIG. 2 illustrates a single-phase and a two-phase circuit with a TVSS.

FIG. 3 illustrates a three-phase circuit with a TVSS.

FIG. 4 is a chart illustrating energy absorbed as a function of MOV tolerance.

FIG. 5 is a schematic of a TMOV.

### VIII. DETAILED DESCRIPTION

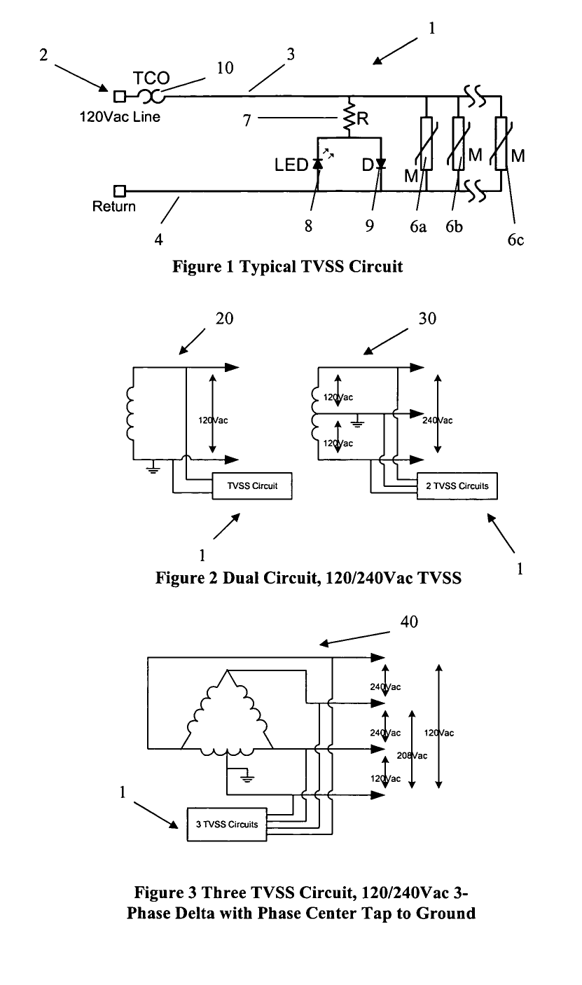

As shown in FIG. 1 and described above, TVSS 1 will have a plurality of MOVs 6. One example of such MOVs are those sold by Littelfuse Corporation of Des Plaines, Ill., under the model designations V20E130, V20E230, V20E320. In the embodiment of FIG. 1, there are three MOVs 6, but the present inventive concept could include fewer or more MOVs depending on the magnitude of the surge the TVSS is designed to protect against. Typically the number of MOVs in the TVSS will be between two and ten. While the TVSS 1 of FIG. 1 shows a circuit with a separate thermal cutoff (TCO) device, the invention also includes commercially available MOVs which have aTCO device integrally formed with the MOV. One series of such devices are sold by Littelfuse Corporation under the model designations TMOV20R130M, TMOV20R230M, and TMOV20R320M. A symbolic representation of such a TMOV 50 is seen in FIG. 5.

While conventional TVSS devices typically are manufactured having MOVs whose nominal voltage varies by as much as ±10%, the present invention is constructed of a plurality of MOVs which are tested and selected to have nominal voltages within a closer tolerance. Such tolerances could be less than approximately ±5%, or more preferably approximately ±2%, and still more preferably approximately ±1% of the mean nominal voltage of the MOVs. By way of example, if the embodiment of FIG. 1 was designed to have a mean clamping or nominal voltage of 202 volts, no MOV in the circuit would have a nominal voltage less than 200 volts or greater than 204 volts (i.e., a ±1% tolerance embodiment). In instances where the MOVs are designed for higher voltages, such as the 360 volt or 510 volt ranges, it may be desirable for the MOVs to be within an even narrower tolerance, such as within +0.5% of one another.

Constructing the TVSS of the present invention normally requires obtaining MOVs within a manufacturer's wider tolerance and sorting the MOVs into narrower tolerances suitable for use in the present invention. The testing of MOVs is typically carried out by increasing the voltage across an MOV until a small test current (on the order of a few milliamperes) is detected. The MOV is rated at the voltage at which the current is detected. The TVSS is then constructed as suggested in FIG. 1 with the designed number of MOVs which all have a rating within the desired tolerance (e.g., less than approximately ±5%, ±2%, ±1% or ±0.5%). Of course, the invention is not limited to the above testing method and any method which could determine the nominal voltage of the MOVs could be employed. Nor is the scope of the present invention limited to a group of closely matched MOVs whose nominal voltage is necessarily identified through testing. For example, the present invention would also include MOVs which are closely matched as a result of the MOVs being specifically manufactured within the disclosed tolerance ranges.

As suggested in FIGS. 2 and 3, a TVSS circuit constructed according to the present invention will typically be connected to each phase of a power source. Thus the single phase circuit 20 in FIG. 2 has one TVSS circuit and the two-phase circuit 30 has two TVSS circuits. In the circuit 30, the TVSSs are identical and each connects across a transformer secondary winding's electric service 120 Vac feeds. FIG. 3 illustrates a three-phase delta circuit 40 having three TVSS circuits attached thereto. This TVSS configuration may be used to protect loads on the secondary of a delta-connected transformer, one phase of which is grounded. Two of the TVSS circuits are identical, with each one protecting a 120 Vac service and the third TVSS circuit has components rated for the “stinger” to neutral circuit.

Computer Modeling Example.

The following computer model was developed illustrating the principles of the present invention. The circuit model was programmed using conventional software such as MATLAB®, produced by The MathWorks, Inc., of 24 Prime Park Way, Natick, Mass., and was representative of the circuit seen in FIG. 1. The varistor model used in the generation of data for this report was a Littelfuse Corporation varistor model no. V130LA20A. Varistors are highly nonlinear devices. In order to model this nonlinearity, a linear piecewise approximation was used. Littelfuse's equation for generation of their VI curves is given by equation 1.

$$\begin{matrix}V = a1 + a2 {log}_{10} ( I ) + \frac{a3}{I} + a4 {ⅇ}^{( - {log}_{10} ( I ) )} + a5 {ⅇ}^{( {log}_{10} ( I ) )} + a6I \\ where \text{:} \\ a1 = 245.6 \\ a2 = 13.53 \\ a3 = - 3.912 \times {10}^{- 5} \\ a4 = 39.9 \times {10}^{- 3} \\ a5 = 3.576 \\ a6 = 0.01458\end{matrix} \qquad ( Eqn . 1 )$$

Equation 1 generates exact voltage and current (VI) point relationships. A linear segment in the model was established by setting endpoints by decades of current (i.e., 0.001A to 0.01A). These segments of current were then fed into equation 1 to compute their associated voltages. With these pairs of voltages and currents, a resistance was found for each pair. To generate resistances for the entire linear segment, a slope was found between the endpoints of each segment. This slope was used to generate a resistance depending on the voltage across the MOV.

In this mathematical modeling, multiple MOVs are paralleled in different combinations. These paralleled MOV combinations are then paralleled with a sample load resistance of approximately 1.1015 Ω resistance. The value, 1.1015 Ω, is the load impedance, real part, as measured by a Dranetz analyzer installed. The value, 0.011 Ω, is the line impedance, real part, as measured by a Dranetz analyzer installed at a test site in Hammond, La. This equivalent parallel resistance is then in series with the approximately 0.011 Ω line resistance. This is the line impedance, real part. The equivalent parallel load resistance and series line resistance act as a voltage divider circuit with most of the voltage delivered to the load. For voltages under 206V (which is the solution to parametric equation 1 with the parameters given by Littelfuse Corp. and thus, is the theoretical nominal voltage for which the MOV is designed), the MOV exhibits very high impedance and, therefore, the equivalent parallel resistance is very close to 1.1015 Ω. For voltages that exceed 206V, the MOV moves into a non-linear characteristic region and its impedance starts to decrease rapidly. As the MOV impedance decreases, the equivalent parallel resistance combination of MOV(s) and load begins decreasing rapidly as higher and higher voltages are seen on the circuit. The decrease in equivalent resistance starts to approach the line resistance. The closer the equivalent MOV/load resistance get to the line resistance, the more the voltage divider network between line resistance and equivalent resistance of the MOV/load interact, and less of the total voltage supplied to the system is delivered to the load. An MOV limits voltage by varying its impedance. The voltage divider network interaction between the parallel combination of MOV/load and line resistance re-routes the power demanded by the decreasing impedance and sinks that power through the MOV(s).

The MOV's operation is dependent on the voltage across it. If the voltage drops below 206V, the MOV(s) effectively turn off as the impedance of the MOV(s) starts rapidly increasing. With a very high resistance in parallel with a 1.1015 Ω load, the parallel combination is effectively 1.1015 Ω. If the voltage across the MOV falls below 206V and effectively turns off the MOV, the voltage remains at the source level. Any positive or negative voltage has the same effect on the impedance of the MOV. Modeling the TVSS in this way, and generating the graphical analysis, illustrates the output of the system as a limited or clamped voltage. This limited or clamped voltage is what would be supplied to the load in a system utilizing the TVSS.

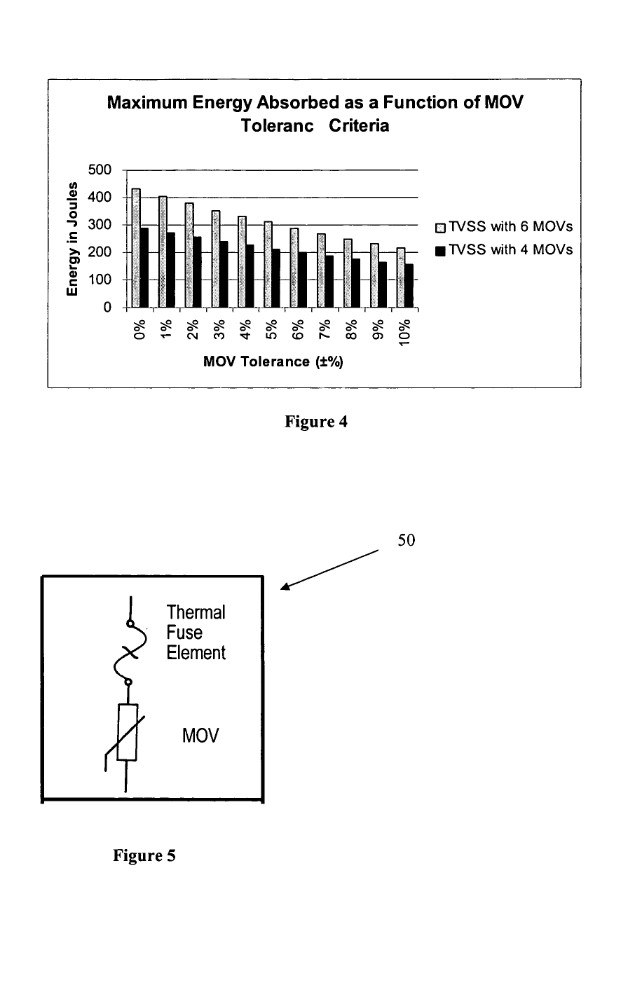

FIG. 4 is a bar graph illustrating MOV tolerance (in+%) versus energy absorbed (in joules) for a circuit having six (or alternatively four) MOVs connected in parallel as modeled by the above described program. FIG. 4 shows the amount of energy absorbed for MOVs matched with various tolerances, from a theoretically perfect match of 0% tolerance to tolerances of ±10% (shown as a total tolerance range of 0% to 10% in FIG. 4). It can be seen that when the MOVs are very poorly matched at ±10% (e.g., one MOV at −10% and the other MOVs at +10%), the six MOVs will only absorb approximately 220 joules of energy. On the other hand, where the MOVs are matched at ±1.0%, the circuit is capable of absorbing a little over 400 joules. It can be seen in FIG. 4 that MOVs matched within a tolerance of approximately ±5% (absorbing approximately 300 joules) have an energy absorption capacity only 75% of theoretically perfectly matched MOVs (i.e., 0% tolerance having an energy absorption capacity somewhat greater than 400 joules).

The modeling data seen in FIG. 4 clearly demonstrates that a TVSS with MOVs not having closely matched nominal voltages will not have an energy absorption capacity commensurate with the number of MOVs. As mentioned previously, the prior art generally presumed a TVSS with six 70 joule MOVs would have an energy absorption rating of 420 joules. However, depending on the range of tolerances of the MOVs within the TVSS, the actual absorption rating of the TVSS could be as little as approximately half that 420 joule value. By selecting MOVs with a tolerance of ±5% or less, the TVSS will reliably have an actual energy absorption rating of at least 75% of the theoretical rating (i.e., number of MOVs multiplied by the MOV rating). A preferred embodiment of the present invention will employ tolerances of less than approximately ±5%, or more preferably less than approximately ±1% or ±0.5%.

While the present invention has been described in terms of specific embodiments, many obvious variations and modifications of the these embodiments will be apparent to those skilled in the art. All such variations and modifications are intended to come within the scope of the following claims.

1. A surge suppression circuit formed by the steps of:
a. testing a series of energy dissipating elements to identify a plurality of energy dissipating elements each having a nominal voltage within less than approximately ±5% of a mean nominal voltage of said plurality; and
b. assembling said plurality of energy dissipating elements into a surge suppression circuit.

2. The surge suppression circuit according to claim 1, wherein said energy dissipating elements are metal oxide varistors.

3. The surge suppression circuit according to claim 2, wherein said metal oxide varistors have a nominal voltage within less than approximately ±2% of a mean nominal voltage of said plurality.

4. The surge suppression circuit according to claim 3, further including at least one thermal cut-off device.

5. The surge suppression circuit according to claim 2, wherein said metal oxide varistors are in a parallel configuration.

6. The surge suppression circuit according to claim 2, wherein said plurality of metal oxide varistors number between two and ten.

7. The surge suppression circuit according to claim 6, wherein said plurality of metal oxide varistors number more than three.

8. A surge suppression circuit formed by the steps of:
a. manufacturing plurality of energy dissipating elements all of which have a nominal voltage within less than approximately ±5% of a mean nominal voltage of said plurality; and
b. assembling said plurality of energy dissipating elements into a surge suppression circuit.

9. The surge suppression circuit according to claim 6, wherein at least one of said metal oxide varistors has a thermal cutoff device formed integrally therewith.
